(19) United States
(12) Patent Application Publication
(10) Pub. No.: US 2024/0170981 A1
(43) Pub. Date: May 23, 2024

(54) OUTDOOR POWER BANK

(71) Applicant: Shenzhen Speedmobile Technology Co., Ltd., Shenzhen (CN)

(72) Inventor: Junwu Ning, Shenzhen (CN)

(21) Appl. No.: 18/127,119

(22) Filed: Mar. 28, 2023

(30) Foreign Application Priority Data
Nov. 21, 2022 (CN) 202223107657.7

(51) Int. Cl. H02J 7/00; F21V 23/04

(52) U.S. Cl. CPC H02J 7/0042; F21V 23/04

(57) ABSTRACT

The present application belongs to the technical field of mobile power supply, in particular to a small outdoor power bank, comprising a battery body, a sound control sensor, a control panel and an outer box with an internal space, the sound control sensor, battery body and the control panel are all installed in the internal space; the outer wall of the outer box is provided with an annual ambient light, and the annual ambient light, sound control sensor and battery body are all electrically connected with the control panel; and the annular ambient light is used for emitting different lights when the sound control sensor receives external sounds. The power bank of this application with ambient lights not only have the function of mobile power supply, but also can emit different lights along with music, thus improving the user experience of the small outdoor power bank.

### CROSS REFERENCE TO RELATED APPLICATIONS

The present application claims the benefit of Chinese Patent Application No. 202223107657.7 filed on Nov. 21, 2022, the contents of which are incorporated herein by reference in their entirety.

### TECHNICAL FIELD

The present application belongs to the technical field of mobile power supply, in particular to an outdoor power bank.

### BACKGROUND

Mobile devices such as cell phones and tablets are becoming increasingly popular, when people go for an outing, they often encounter the technical problem that the mobile phone has no electricity and need to charge the mobile phone in time. Power bank refers to a device that can directly charge mobile devices and has its own power storage unit. When people go for an outing, they often carry a mobile power supply, in case the mobile devices such as mobile phones run out of power.

In the prior art, the function of power bank is relatively single. Usually, it can merely charge mobile terminals (mobile phones, etc.), the user experience is not good.

### SUMMARY

Aiming at the technical problem that the power bank in the prior art has relatively single function, the present application provides a small outdoor power bank.

In view of the above technical problem, the embodiments of the present application provides a small outdoor power bank, including a battery body, a sound control sensor, a control panel and an outer box with an internal space, the sound control sensor, the battery body and the control panel are all installed in the internal space; an outer wall of the outer box is provided with an annual ambient light, and the annual ambient light, the sound control sensor and the battery body are all electrically connected with the control panel; and the annular ambient light is configured for emitting different lights when the sound control sensor receives external sounds.

Optionally, the small outdoor power bank further includes a knob rotatably installed on the outer box, the knob is electrically connected with the control panel, and the knob is configured for controlling brightness of the annular ambient light.

Optionally, the small outdoor power bank further includes a button installed on the knob, the button is electrically connected with the control panel, and the button is configured for controlling a working mode of the annular ambient light.

Optionally, the small outdoor power bank further includes a handle rotatably installed on the outer wall of the outer box.

Optionally, the outer box includes a cover plate, a box and a lamp base installed between the box and the cover plate, and the internal space includes a first space arranged on the box and a second space arranged on the lamp base; the annular ambient light is arranged on the lamp base, the battery body is installed in the first space, and the control panel and the sound control sensor are both installed in the second space.

Optionally, the cover plate is a reflector, and the small outdoor power bank further includes a battery capacity indicator installed on the lamp base, the battery capacity indicator is electrically connected with the control panel, and is configured for displaying electric quantity of the battery body through the reflector.

Optionally, the lamp base is provided with a clamping groove, an inner wall of the first space is provided with a buckle, and the lamp base covers an opening of the first space through the buckle clamped in the clamping groove.

Optionally, the lamp base includes a base body provided with the second space and a cover body covering the base body.

Optionally, the annular ambient light includes an annular light-guide part arranged on the outer wall of the outer box and a plurality of lamp beads arranged on the control panel, and the plurality of lamp beads are annularly distributed at intervals.

Optionally, the outer box is further provided with a power transmission interface and a charging interface, both the power transmission interface and the charging interface are electrically connected with the control panel, the power transmission interface is configured for charging external electrical equipment, and the charging interface is configured for charging the battery body.

In the present application, the sound control sensor, battery body and control panel are all installed in the internal space. The outer wall of the outer box is provided with an annual ambient light, and the annual ambient light, sound control sensor and battery body are all electrically connected with the control panel. When the sound control sensor and the annual ambient light are both turned on, and the annual ambient light receives external sounds such as music, the control panel controls the annual ambient light to emit lights with different colors and dynamic effects along with the external sounds. Therefore, the power bank with ambient lights not only have the function of mobile power supply, but also can emit different lights along with music, thus improving the user experience of the small outdoor power bank. In addition, the annual ambient light encircles the outer box, and the annular ambient light can also function as an illuminating lamp, thus further enriching the functions of the small outdoor power bank.

### BRIEF DESCRIPTION OF THE DRAWINGS

The present application will be further illustrated with reference to the attached drawings and embodiments.

FIG. 1 is a structural schematic diagram of a small outdoor power bank provided by an embodiment of the present application;

FIG. 2 is a sectional view of a small outdoor power bank provided by an embodiment of the present application;

FIG. 3 is a structural schematic diagram of a knob of a small outdoor power bank provided by an embodiment of the present application;

FIG. 4 is a structural schematic diagram of a box of a small outdoor power bank provided by an embodiment of the present application;

FIG. 5 is a structural schematic diagram of a lamp base of a small outdoor power bank provided by an embodiment of the present application.

Reference signs in the drawings are as follows:

1. Outer box; 11. Internal space; 111. First space; 112. Second space; 12. Annular ambient light; 13. Cover plate; 14. Box; 141. Buckle; 15. Lamp base; 151. Clamping groove; 152. Base body; 153. Cover body; 2. Knob; 21. Button; 3. Power transmission interface; 4. Charging interface; 5. Handle.

### DETAILED DESCRIPTION OF DISCLOSED EMBODIMENTS

In order to make the beneficial effects, technical solutions and technical problems solved by the present application clearer, the present application will be further illustrated in detail with reference to the drawings and embodiments. It should be understood that the specific embodiments described here are merely for illustrating the present application, not for limiting the present application.

It should be understood that the orientation or positional relationship indicated by the terms “upper”, “lower”, “left”, “right”, “front”, “rear” and “middle” is based on the orientation or positional relationship shown in the attached drawings, only for the convenience of describing the present application and simplifying the description, and does not indicate or imply that the device or element referred to must have a specific orientation, be constructed or operated in a specific orientation. Therefore, it is not intended to limit the scope of the present application.

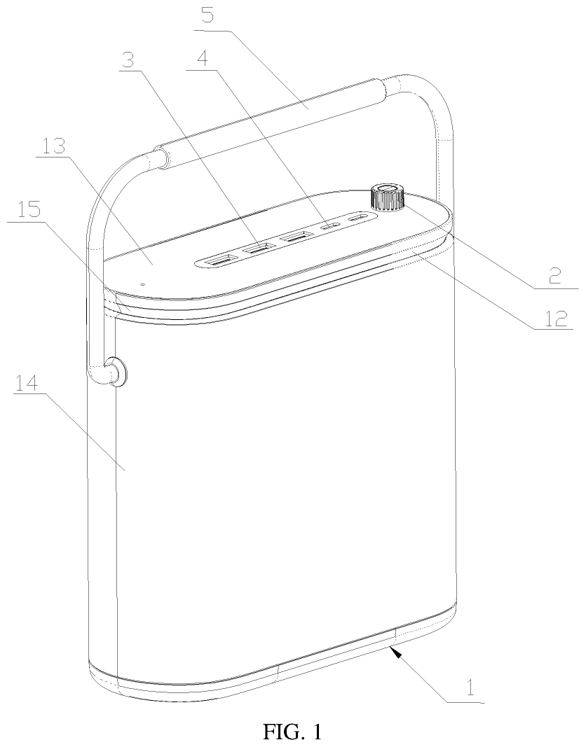

As shown in FIG. 1, a small outdoor power bank provided by an embodiment of the present application includes a battery body (not shown), a sound control sensor (not shown), a control panel (not shown) and an outer box 1 provided with an internal space 11, wherein the sound control sensor, the battery body and the control panel are all installed in the internal space 11; an outer wall of the outer box 1 is provided with an annual ambient light 12, and the annual ambient light 12, the sound control sensor and the battery body are all electrically connected with the control board. Understandably, the battery body is a rechargeable battery; the outer box 1 is also provided with a power transmission interface 3 and a charging interface 4, both of which are electrically connected with the control panel, the power transmission interface 3 is used for charging external electric devices (mobile phones, tablets, etc.) and the charging interface 4 is used for charging the battery body. That is, both the power transmission interface 3 and charging interface 4 are electrically connected with the battery body through the control panel, and the battery body can charge external electric devices such as mobile phones and tablets through data line of the power transmission interface 3, and the external power supply charges the battery body through a charger connected with the charging interface 4.

The annular ambient light 12 is configured for emitting different lights when the sound control sensor receives external sounds. Understandably, the annular ambient light 12 can emit lights with different colors and different dynamic effects according to the music with different tones received by the sound control sensor.

In the present application, the sound control sensor, battery body and control panel are all installed in the internal space 11. The outer wall of the outer box 1 is provided with an annual ambient light 12, and the annual ambient light 12, sound control sensor and battery body are all electrically connected with the control panel. When the sound control sensor and the annual ambient light 12 are both turned on, and the annual ambient light 12 receives external sounds such as music, the control panel controls the annual ambient light 12 to emit lights with different colors and dynamic effects along with the external sounds. Therefore, the power bank with ambient lights not only have the function of mobile power supply, but also can emit different lights along with music, thus improving the user experience of the small outdoor power bank. In addition, the annual ambient light 12 encircles the outer box 1, and the annular ambient light 12 can also function as an illuminating lamp, thus further enriching the functions of the small outdoor power bank.

In an embodiment, as shown in FIG. 1, the small outdoor power bank further includes a knob 2 rotatably installed on the outer box 1, the knob 2 is electrically connected with the control panel, and the knob 2 is configured for controlling brightness of the annular ambient light 12. Understandably, the knob 2 is arranged at the top of the outer box 1, and the user can adjust the brightness of the annular ambient light 12 by rotating the knob 2.

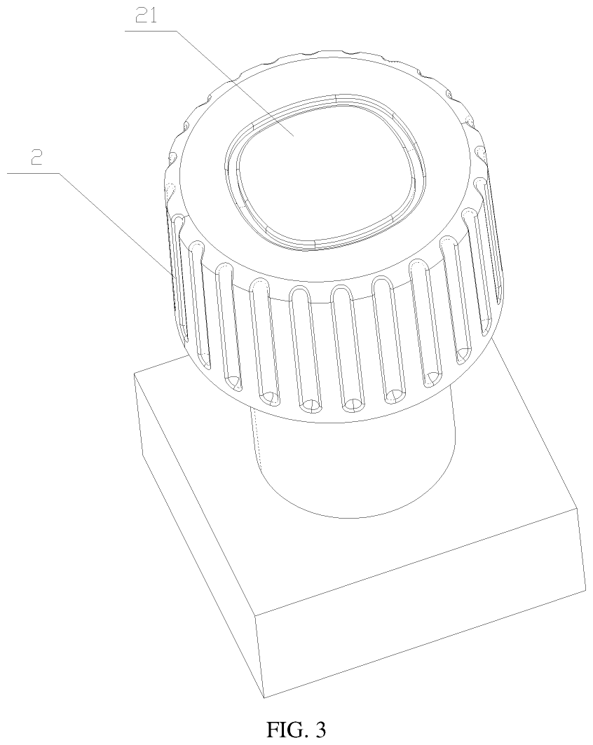

In an embodiment, as shown in FIGS. 1 and 3, the small outdoor power bank further includes a button 21 installed on the knob 2, the button 21 is electrically connected with the control panel and used for controlling the working mode of the annular ambient light 12. Understandably, the annual ambient light 12 has two modes, i. e., the annual ambient light 12 can be in an ambient light mode or an illumination light mode. Specifically, by pressing the button 21 on the knob 2, the annular ambient light 12 can be controlled to be on/off, or in the modes of ambient light or illumination light. When the annual ambient light 12 is in the illumination light mode, the brightness of the light emitted by the annual ambient light 12 is controlled by rotating the knob 2, and the small outdoor power bank can play a role in lighting. In this embodiment, the button 21 is arranged on the knob 2, which improves the compactness and aesthetics of the small outdoor power bank.

In an embodiment, as shown in FIG. 1, the small outdoor power bank further includes a handle 5 rotatably installed on the outer wall of the outer box 1. Understandably, the two opposite ends of the handle 5 are rotatably installed on the two opposite outer walls of the outer box 1, and the handle 5 can be rotated above the box 14, so that the user can lift the small outdoor power bank via the handle 5, thereby improving the portability of the small outdoor power bank.

Preferably, the small outdoor power bank further includes a sleeve rotatably sleeved on the handle 5, and the sleeve increases the outer diameter of the handle 5, thereby improving the comfort of a user holding the handle 5.

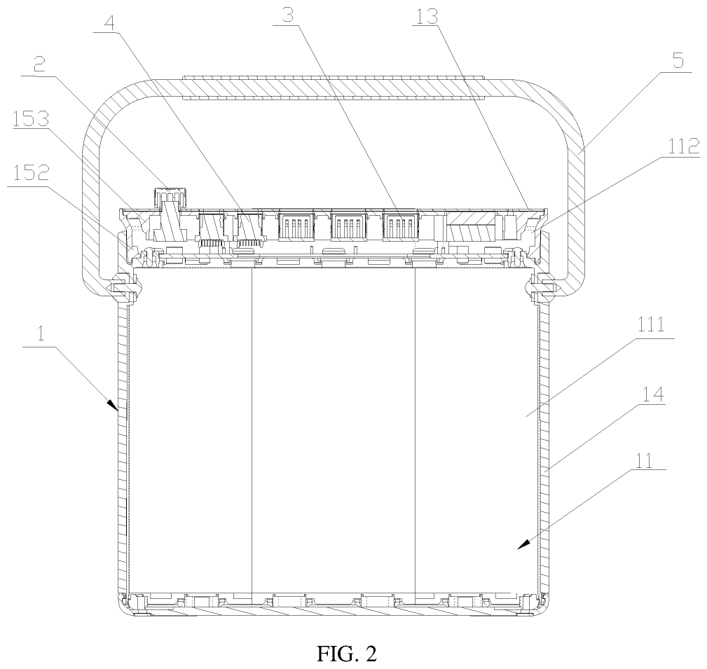

In an embodiment, as shown in FIG. 2, the outer box 1 includes a cover plate 13, a box 14 and a lamp base 15 installed between the box 14 and the cover plate 13, and the internal space 11 includes a first space 111 and a second space 112 arranged on the lamp base 15; the annular ambient light 12 is arranged on the lamp base 15, the battery body is installed in the first space 111, and the control panel and the sound control sensor are both installed in the second space 112. Understandably, the bottom of the lamp base 15 is inserted into the first space 111 of the box 14, the cover plate 13 covers the top of the lamp base 15, and the annular ambient light 12 is arranged between the cover plate 13 and the box 14. In this embodiment, the battery body is installed in the first space 111 of the box 14, and the sound control sensor and the controller are installed in the second space 112 of the lamp base 15, thus avoiding the interference between the battery body, the control panel and the sound control sensor, and prolonging the user experience of the small outdoor power bank.

In an embodiment, as shown in FIG. 1, the cover plate 13 is a reflector, and the small outdoor power bank further includes a battery capacity indicator (not shown in the figure) installed on the lamp base, the battery capacity indicator is electrically connected with the control panel, and is configured for displaying electric quantity of the battery body through the reflector. Understandably, the battery capacity indicator may be a digital indicator lamp (the remaining capacity in the battery body may be indicated digitally), a single indicator lamp (the remaining capacity in the battery body may be indicated by the number of scale lines), a plurality of indicator lamps (the remaining capacity in the battery body may be indicated by the number of bright indicator lamps), and the like. In this embodiment, the battery capacity indicator is arranged at the top of the lamp base and below the reflector, thus avoiding the interference of the external environment on the battery capacity indicator. When the battery capacity indicator is in the state of light off, the battery capacity indicator cannot be seen from outside, thus improving the aesthetics of the small outdoor power bank. The battery capacity indicator is only used when the light is on, and the user can see the indication of the battery capacity indicator.

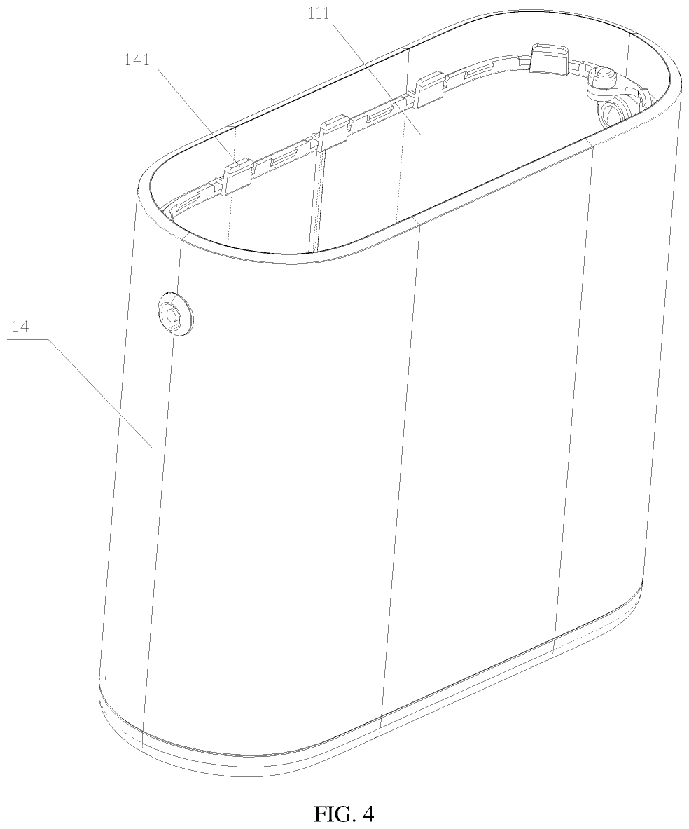

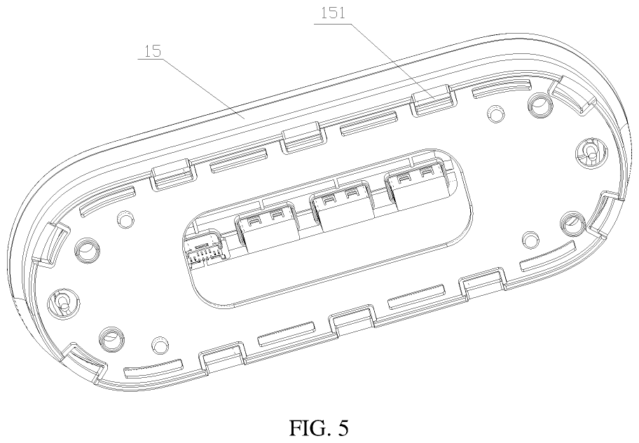

In an embodiment, as shown in FIGS. 4 and 5, the lamp base 15 is provided with a clamping groove 151, the inner wall of the first space 111 is provided with a buckle 141, and the lamp base 15 covers the opening of the first space 111 through the buckle 141 clamped in the clamping groove 151. Understandably, the clamping groove 151 is arranged at the bottom of the lamp base 15 and communicates with the second space 112; the lamp base 15 is provided with a plurality of clamping grooves 151 distributed at intervals, and the inner wall of the first space 111 is provided with a plurality of buckles 141 distributed at intervals, and the buckle 141 extend into the second space 112 through the clamping grooves 151 and is clamped at the edge of the clamping groove 151. In this embodiment, the lamp base 15 detachably covers the box 14 through the buckle 141 clamped in the clamping groove 151, which improves the convenience of disassembly and assembly between the lamp base 15 and the box 14, and facilitates the user to overhaul the internal devices of the small outdoor power bank.

In an embodiment, as shown in FIG. 2, the lamp base 15 includes a base body 152 provided with the second space 112 and a cover body 153 covering the base body 152. Understandably, the cover body 153 detachably covers the base body 152, thus facilitating the maintenance of the control panel, sound control sensor and other components in the second space 112.

In an embodiment, as shown in FIG. 1, the annular ambient light 12 includes an annular light-guide part arranged on the outer wall of the outer box 1 and a plurality of lamp beads (not shown in the figure) arranged on the control panel, and the plurality of lamp beads are annularly distributed at intervals. Understandably, the lamp beads include, but are not limited to, LED lamps and the like, and the number of the lamp beads may be designed according to actual needs. The annular light-guide part is made of light-transmitting materials, and a plurality of the lamp beads emit light in the second space 112, and the lamp beads are emitted through the annular light-guide part, thus forming an annular light-emitting section on the lamp base 15.

The above descriptions are only preferred embodiments of the small outdoor power bank of the present application, and are not intended to limit the present application. Any modifications, equivalent substitutions and improvements made within the spirit and principle of the present application shall be included in the protection scope of the present application.

What is claimed is:

1. An outdoor power bank, comprising a battery body, a sound control sensor, a control panel and an outer box with an internal space, the sound control sensor, the battery body and the control panel are all installed in the internal space; an outer wall of the outer box is provided with an annual ambient light, and the annual ambient light, the sound control sensor and the battery body are all electrically connected with the control panel; and
the annular ambient light is configured for emitting different lights when the sound control sensor receives external sounds.

2. The outdoor power bank of claim 1, wherein the outdoor power bank further comprises a knob rotatably installed on the outer box, the knob is electrically connected with the control panel, and the knob is configured for controlling brightness of the annular ambient light.

3. The outdoor power bank of claim 2, wherein the outdoor power bank further comprises a button installed on the knob, the button is electrically connected with the control panel, and the button is configured for controlling a working mode of the annular ambient light.

4. The outdoor power bank of claim 1, wherein the outdoor power bank further comprises a handle rotatably installed on the outer wall of the outer box.

5. The outdoor power bank of claim 1, wherein the outer box comprises a cover plate, a box and a lamp base installed between the box and the cover plate, and the internal space comprises a first space arranged on the box and a second space arranged on the lamp base; the annular ambient light is arranged on the lamp base, the battery body is installed in the first space, and the control panel and the sound control sensor are both installed in the second space.

6. The outdoor power bank of claim 5, wherein the cover plate is a reflector, and the outdoor power bank further comprises a battery capacity indicator installed on the lamp base, the battery capacity indicator is electrically connected with the control panel, and is configured for displaying electric quantity of the battery body through the reflector.

7. The outdoor power bank of claim 5, wherein the lamp base is provided with a clamping groove, an inner wall of the first space is provided with a buckle, and the lamp base covers an opening of the first space through the buckle clamped in the clamping groove.

8. The outdoor power bank of claim 5, wherein the lamp base comprises a base body provided with the second space and a cover body covering the base body.

9. The outdoor power bank of claim 1, wherein the annular ambient light comprises an annular light-guide part arranged on the outer wall of the outer box and a plurality of lamp beads arranged on the control panel, and the plurality of lamp beads are annularly distributed at intervals.

10. The outdoor power bank of claim 1, wherein the outer box is further provided with a power transmission interface and a charging interface, both the power transmission interface and the charging interface are electrically connected with the control panel, the power transmission interface is configured for charging external electrical equipment, and the charging interface is configured for charging the battery body.
